(19) United States
(12) Patent Application Publication
(10) Pub. No.: US 2018/0098120 A1
(43) Pub. Date: Apr. 5, 2018

(54) ELECTRONIC DEVICE AND CONTROLLING METHOD THEREOF

(71) Applicant: Samsung Electronics Co., Ltd., Suwon-si (KR)

(72) Inventors: Kyung-ik CHO, Suwon-si (KR); Je-hwan Seo, Daegu (KR); Seung-il Yoon, Yongin-si (KR); Hyun-kyu Yun, Seoul (KR)

(73) Assignee: Samsung Electronics Co., Ltd., Suwon-si (KR)

(21) Appl. No.: 15/715,882

(22) Filed: Sep. 26, 2017

(30) Foreign Application Priority Data
Oct. 4, 2016 (KR) 10-2016-0127631

(51) Int. Cl. H04N 21/442; H04N 21/4363; H04N 5/44; H04N 5/46

(52) U.S. Cl. CPC H04N 21/44231; H04N 5/46; H04N 5/44; H04N 21/43635

(57) ABSTRACT

An electronic device includes an interface configured to be connected to an external device, a detection circuit configured to generate an interrupt when the external device is connected to the interface in a power save mode while the interface is not activated, and a processor configured to, in response to the interrupt occurring, activate the interface by converting the electronic device to be in a normal mode, and control the interface to detect whether the external device is connected.

### CROSS-REFERENCE TO RELATED APPLICATIONS

This application claims priority from Korean Patent Application No. 10-2016-0127631, filed on Oct. 4, 2016, in the Korean Intellectual Property Office, the disclosure of which is incorporated herein by reference in its entirety.

### BACKGROUND

### 1. Field

Devices and methods consistent with what is disclosed herein relate to an electronic device and a controlling method thereof, and more particularly, to an electronic device which provides a different operation mode depending on whether an external device is connected and a controlling method thereof.

### 2. Description of the Related Art

With the development of electronic technology, various external devices providing contents such as a set-top box, a DVD, and an audio can be connected to a display device such as an electronic device, for example, a TV.

Meanwhile, in order to detect whether a cable such as HDMI is attached or detached, the electronic device is generally supplied with power continuously for detecting whether or not the external device is connected.

However, the power is continuously consumed even when a user does not use the electronic device, which causes a waste of power.

Accordingly, a method for consuming only a minimum amount of power in a standby state when the electronic device is not used is required.

### SUMMARY

An aspect of the exemplary embodiments relates to an electronic device which detects whether or not a cable is attached only when an external device is connected and an interruption occurs and a controlling method thereof.

An electronic device according to an exemplary embodiment includes an interface configured to be connected to an external device, a detection circuit configured to generate an interrupt when the external device is connected to the interface in a power save mode while the interface is not activated, and a processor configured to, in response to the interrupt occurring, activate the interface by converting the electronic device to be in a normal mode, and control the interface to detect whether the external device is connected.

The detection circuit may include a pull-up resistor and a switching transistor.

The detection circuit, in response to the external device being connected to the interface while outputting a high level, may switch the switching transistor to output a low level, and the processor, in response to a signal output from the detection circuit is transitioned from a high level to a low level, may determine that the interrupt occurs.

The detection circuit may turn on a switching transistor which has been turned off according to a signal generated as the external device is connected to the interface, and output the low level when the pull-up resistor is connected to ground as the switching transistor is turned on.

The processor may control the interface to detect whether the external device is detached from the interface in the normal mode, and if it is determined that the external device is detached from the interface, convert a mode of the electronic device from the normal mode to the power save mode.

The device may further include a display, and the processor may control the display to display information regarding a mode in which the electronic device is operated and information regarding an input/output port to which the external device is connected from among a plurality of input/output ports composing the interface.

A controlling method of an electronic device according to an exemplary embodiment includes operating in a power save mode in which whether an external device is connected is not detected, generating an interrupt in response to the external device being connected, and in response to the interrupt being generated, converting a mode to a normal mode in which whether the external device is connected is detected.

The interrupt may be generated by a pull-up resistor and a switching transistor.

The step in which the interrupt is generated may include, in response to the external device being connected while the electronic device outputs a high level, outputting a low level by switching the switching transistor, and in response to a signal output from the electronic device being transitioned from a high level to a low level, generating the interrupt.

The outputting a low level may include turning on a switching transistor which has been turned off according to a signal generated as the external device is connected, and outputting the low level when the pull-up resistor is connected to ground as the switching transistor is turned on.

The method may further include detecting whether the external device is detached in the normal mode, and if it is determined that the external device is detached, converting a mode from the normal mode to the power save mode.

The method may further include displaying information regarding an operation mode of the electronic device and information regarding an input/output port of the electronic device to which the external device is connected.

According to the above-described various exemplary embodiments, the electronic device which does not detect whether a cable is attached or detached while an external device is not connected can be provided and thus, a user may use the electronic device which uses only minimum amount of power.

### BRIEF DESCRIPTION OF THE DRAWINGS

The above and/or other aspects will be more apparent by describing certain exemplary embodiments of the present with reference to the accompanying drawings, in which:

FIG. 1 is a view provided to explain a control system of an electronic device according to an exemplary embodiment;

FIG. 2 is a block diagram provided to explain configuration of an electronic device according to an exemplary embodiment;

FIG. 3 is a view provided to explain a detection circuit of an electronic device according to an exemplary embodiment;

FIG. 4 is a flowchart provided to explain an operation process of an electronic device according to an exemplary embodiment;

FIG. 5 is a block diagram illustrating an example of detailed configuration of an electronic device when the electronic device is implemented as a display apparatus according to an exemplary embodiment; and

FIG. 6 is a flowchart provided to explain an operation process of an electronic device according to an exemplary embodiment.

### DETAILED DESCRIPTION OF EXEMPLARY EMBODIMENTS

The terms used in the present disclosure and the claims are general terms selected in consideration of the functions of the various example embodiments of the present disclosure. However, these terms may vary depending on intention, legal or technical interpretation, emergence of new technologies, and the like of those skilled in the related art. Also, there may be some terms arbitrarily selected by an applicant. These terms may be interpreted based on the definition there of in this specification, and unless there is a specific definition of a term, the term may be understood based on the overall contents and technological common sense of those skilled in the related art.

In describing example embodiments, detailed description of relevant known functions or components may be omitted if it would obscure the description of the subject matter.

Further, the exemplary embodiments will be described in detail with reference to the drawings, but the technical features of the present disclosure are not limited thereto.

Hereinafter, an electronic device according to an exemplary embodiment will be described with reference to corresponding drawings.

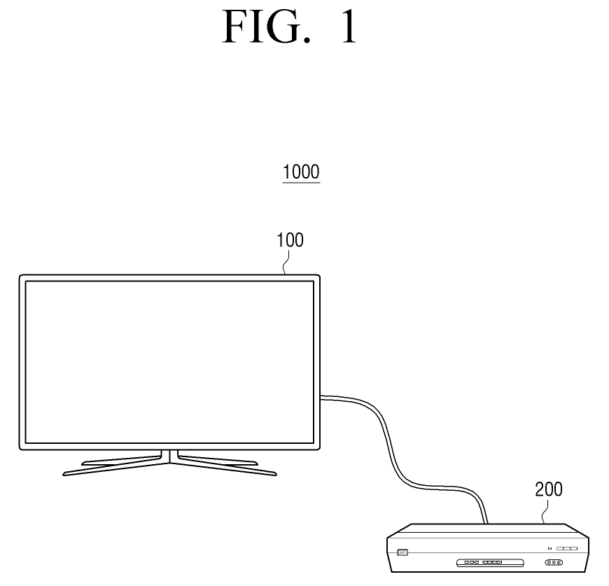

FIG. 1 is a view provided to explain a control system of an electronic device according to an exemplary embodiment.

As illustrated in FIG. 1, an electronic system 1000 includes an electronic device 100 and an external device 200.

The electronic device 100 is connected to the external device 200. For example, the electronic device 100 and the external device 200 may be connected to each other according to a High Definition Multimedia Interface (HDMI) method.

Here, the electronic device 100 may be implemented as a TV, etc. which may display an image, and the external device 200 may be implemented as a set-top box, a Blu-ray player, etc. However, this is only an example, and the electronic device 100 and the external device 200 may be implemented as various types of devices which may be connected to each other using a HDMI method.

Meanwhile, even if the electronic device is not in use, that is, if the electronic device is in a standby state, in general, power is continuously supplied in order to detect connection with an external device. However, this may cause unnecessary power consumption continuously and thus, there is a need to provide only a minimum amount of power when the electronic device is in a standby state.

To achieve this, the electronic device 100 according to an exemplary embodiment supplies power to detect connection with the external device 200 only when the external device 200 is connected.

Specifically, the electronic device 100 supplies power to detect connection with the external device 200 only when the external device 200 is connected, and does not provide power to detect connection with the external device 200 and provides only a minimum amount of power to maintain the standby state when the external device 200 is not connected.

Hereinafter, an operation mode of the electronic device 200 according to whether the electronic device 100 and the external device 200 are connected will be described in detail.

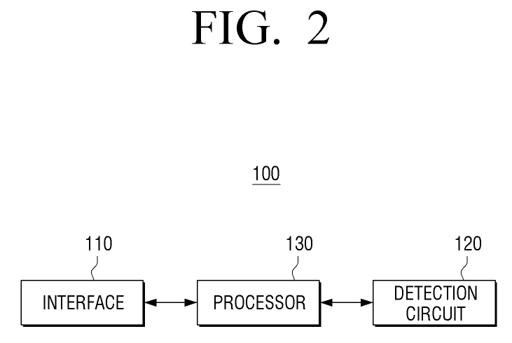

FIG. 2 is a block diagram provided to explain configuration of an electronic device according to an exemplary embodiment.

Referring to FIG. 2, the electronic device 100 includes an interface 110, a detection circuit 120 and a processor 130.

The interface 110 is connected to the external device 200.

Accordingly, the interface 100 may receive various pieces of data from the external device 200.

To achieve this, the interface 110 may be implemented as various types of ports. For example, if the interface 100 is connected to the external device 200 according to the HDMI method, the interface 110 may include an HDMI communication module.

The detection circuit 120 generates an interrupt when the external device 200 is connected to the interface 110 while the electronic device 100 operates in a power save mode.

Here, the power save mode refers to a mode in which the interface 110 is not activated. In other words, the electronic device 100 does not provide power to the interface 110 in the power save mode and thus, the interface 110 does not detect whether the external device 200 is connected.

If the external device 200 is connected to the interface 110 while the electronic device 100 operates in the power save mode, the detection circuit 120 generates an interrupt.

Here, the interrupt is a signal indicating that the external device 200 is connected to the interface 110, and when a signal output from the detection circuit 120 is transitioned from a high level to a low level, it is determined that an interrupt occurs.

Hereinafter, the process of an interrupt being generated in the detection circuit 120 will be described in detail.

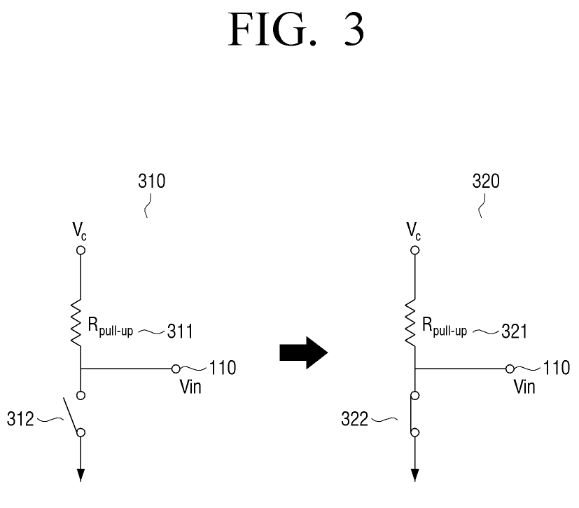

Referring to FIG. 3, the detection circuit 120 includes a pull-up resistor 310 and a switching resistor 320.

The detection circuit 120 has a structure where it is connected to the interface 110, and a voltage Vin may be pre-input in/to an input/output port pin of the interface 110.

Firstly, the switching transistor 320 maintains its turn-off state while the electronic device 100 operates in the power save mode.

In other words, in case that the external device 200 is not connected to the interface 110, the switching transistor 312 of the detection circuit maintains the turn-off state and accordingly, the voltage Vin which is pre-input in the input/output port pin of the interface 110 is maintained as it is. As a result the detection circuit 120 may output a high level.

Subsequently, when the external device 200 is connected to the interface 110, the detection circuit 120 may output a low level by switching the switching transistor 320.

Specifically, if the external device 200 is connected to the interface 110 of the electronic device 100 via an HDMI cable, the input/output port pin of the interface 110 may be influenced by the voltage applied to a terminal of the HDMI cable. Therefore, when a voltage change of the input/output port pin of the interface 110 is detected, the electronic device 100 may generate an internal control signal and transmit the signal to the switching transistor 320. Here, the internal control signal may include a command to change the switch of the switching transistor 320.

In this case, if the switching transistor 320 changes the switch from an off state to an on state according to the internal control signal, the input/output port pin of the interface 110 is connected to ground and the detection circuit 120 may output a low level.

Accordingly, the detection circuit 120 may generate an interrupt by an output signal which is transitioned from a high level to a low level.

The processor 130 controls the overall operations of the electronic device 100.

To achieve this, the processor 130 may include central processing unit (CPU), Random Access Memory (RAM) and Read Only Memory (ROM) and execute operation or data processing regarding the control of other elements included in the electronic device 100.

When the electronic device 100 is connected to the external device 200 through the interface 110, the processor 130 may control the interface 110 to transmit the internal control signal to the detection circuit 120. Here, the internal control signal may include a command to change the switch of the switching transistor 320.

Accordingly, when the switch of the switching transistor 320 is turned on after being turned off, the detection circuit 120 generates an interrupt, and as the interrupt occurs, the processor 130 may switch the power save mode of the electronic device 100 to a normal mode. In other words, the interface 110 is activated and controlled to detect whether the external device 200 is connected.

Specifically, when an interrupt occurs, the processor 130 may control the interface 110 according to an interrupt processing routine.

Here, the interrupt processing routine may be a group of commands to activate the interface 110 of the electronic device 100.

Specifically, the interrupt processing routine may be a group of commands to supply power so that the electronic device 100 may activate the interface 110 and accordingly, the interface 110 may detect connection with the external device 200.

In other words, when an interrupt occurs, the processor 130 may control the electronic device 100 to operate in the normal mode in which connection with the external device 200 is detected according to the interrupt processing routine. Thus, the interface 100 may perform the operation of detecting whether the external device 200 is connected by Hot Plug Detect (HPD).

In addition, if it is determined that the external device 200 is detached from the interface 110 of the electronic device 100 while the processor 130 operates in the normal mode, the processor 130 may switch the mode of the electronic device 100 from the normal mode to the power save mode.

Specifically, if the HDMI cable is detached from the interface 110 of the electronic device 100, the input/output port pin of the interface 110 may not be influenced by the voltage applied to the terminal of the HDMI cable. Therefore, when a voltage change of the input/output port pin of the interface 110 is detected, the electronic device 100 may generate an internal control signal and transmit the signal to the switching transistor 320. Here, the internal control signal may include a command to change the switch of the switching transistor 320.

Subsequently, if the state of the switching transistor 312 is switched from an on state to an off state according to the internal control signal, a pre-input voltage Vin is applied to the input/output port pin and the detection circuit 120 outputs a high level again. Accordingly, the processor 130 may return to the power save mode which is the original operation state to operate the electronic device 100.

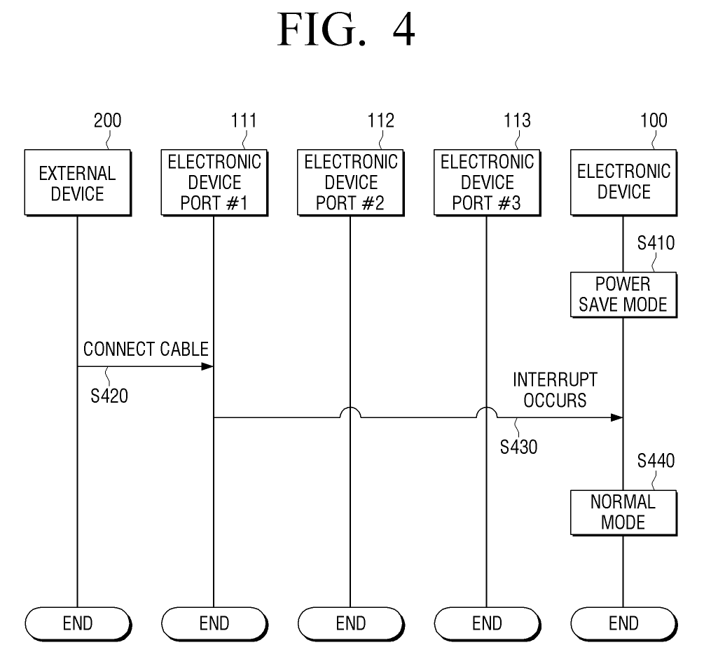

FIG. 4 is a flowchart provided to explain a process in which an electronic device according to an exemplary embodiment operates.

Firstly, the electronic device 100 operates in the power save mode in its initial state where the external device 200 is not connected (S410). Meanwhile, as mentioned above, even if it is not the initial state where the external device 200 is not connected, the electronic device 100 may operate in the power save mode if the connection to the external device 200 is cut off.

Subsequently, if the cable of the external device 200 is connected through PORT#1(111), as mentioned above, PORT#1(111) of the electronic device 100 receives a signal generated from the external device 200 and accordingly, generates an interrupt. Thus, the electronic device 100 may detect the interrupt. The electronic device 100 may switch the operation mode from the power save mode to the normal mode according to the detected interrupt (S440). In other words, the electronic device supplies power to detect whether the external device 200 is connected while operating in the normal mode. Thus, the interface may perform the operation of detecting whether an external device is connected by HPD.

Meanwhile, three input/output ports 111˜113 of the electronic device are illustrated in FIG. 4, but the number of input/output ports is not limited thereto. In addition, even when the external device 200 is connected to PORT#2(112) or PORT#3(113), the operation will be the same as mentioned above. In addition, in this exemplary embodiment, the electronic device 100 is switched to be in the normal mode and then, ended. However, as mentioned above, it is also possible that when the connection with the external device 200 is cut off, the electronic device 100 operates in the power save mode again.

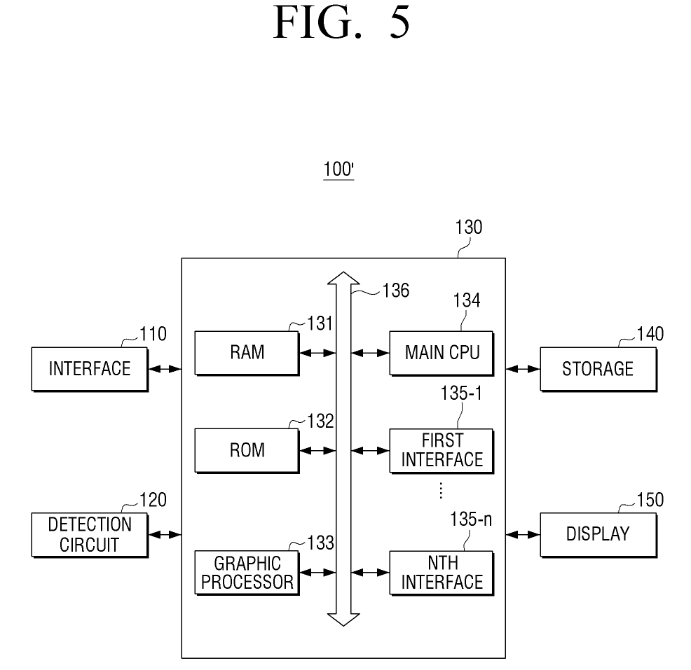

FIG. 5 is a block diagram illustrating an example of detailed configuration of a display device when the display device according to an example embodiment is implemented as a display device.

As shown in FIG. 5, an electronic device 100′ according to an exemplary embodiment includes the interface 110, the detection circuit 120, the processor 130, storage 140, and a display 150. Hereinafter, the elements which are overlapped with those in FIG. 2 will be omitted.

First, if the electronic device 100 is not connected to the external device 200, the storage operates in the power save mode, and if the electronic device 100 is connected to the external device 200, an algorithm to operate the storage 140 in the normal mode may be stored.

Such an algorithm may be implemented as software, a program and so on, and may be implemented (for example, executed) by the processor 130.

In addition, the storage 140 may store an Operating System (OS) to control the overall operations of the electronic device 100′ and commands or data related to the elements of the electronic device 100′.

Accordingly, the processor 130 may control a plurality of hardware or software elements of the electronic device 100′ using the various commands or data stored in the storage 140, load commands or data received from at least one of other elements on a volatile memory, process the commends or data, and store various data in a non-volatile memory.

The display 150 may display information regarding the mode in which the electronic device 100′ is in operation and information regarding the input/output port to which the external device 200 is connected from among a plurality of input/output ports composing the interface 110.

Here, the mode in which the electronic device 100′ is in operation may be the power save mode or the normal mode, and the information regarding the input/output port may be information regarding the number of the input/output port of the interface 110 to which the external device 200 is connected and information regarding whether the input/output port is turned on or turned off.

To achieve this, the display 150 may be implemented as Liquid Crystal Display Panel (LCD), Organic Light Emitting Diodes (OLED), or the like, but is not limited thereto.

The processor 130 controls the overall operations of the electronic device 100′.

Specifically, the processor 130 includes a RAM 131, a ROM 132, a graphics processor 133, a central processing unit (CPU) 134, first through nth interfaces 135-1˜135-n and a bus 136. Here, the RAM 131, the ROM 132, the graphic processing unit 133, the main CPU 134, the first to nth interfaces 135-1 to 135-n, and the like may be connected to each other through the bus 136.

The first to nth interfaces 135-1˜135-n are connected to the various elements mentioned above. One of the interfaces may also be a network interface connected to an external device through a network.

The main CPU 134 accesses the storage 140, and performs booting using an O/S stored in the storage 140. The main CPU 134 may perform various operations by using various types of programs, contents, and data, etc. stored in the storage 140.

The RAM 131 stores a set of commands for system booting. If a turn-on command is input and power is provided, the main CPU 134 may copy an operating system (O/S) stored in the storage 140, in the RAM 131, according to a command stored in the ROM 132, and execute the O/S so that a system is booted. When the booting is completed, the main CPU 134 copies various programs stored in the storage 140, in the RAM 131, and executes the programs copied in the RAM 131 to perform various operations.

The display 130 may control the display 150 to display information regarding the mode in which the electronic device 100′ is in operation and information regarding the input/output port to which the external device 200 is connected from among a plurality of input/output ports composing the interface 110.

Here, the mode in which the electronic device 100′ is in operation may be the power save mode or the normal mode, and the information regarding the input/output port may be information regarding the number of the input/output port of the interface 110 to which the external device 200 is connected and information regarding whether the input/output port is turned on or turned off.

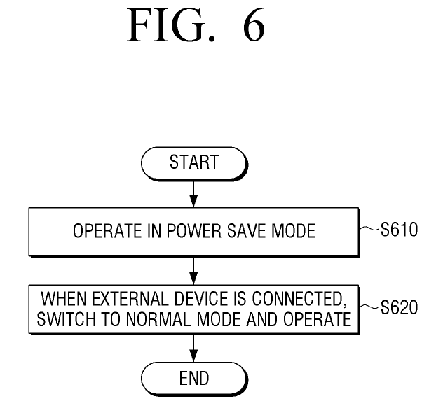

FIG. 6 is a flowchart provided to explain the process where an electronic device according to an exemplary embodiment operates.

Firstly, the electronic device 100 operates in the power save mode in the state where the external device 200 is not connected (S610). In other words, the electronic device 100 may maintain the state where the electronic device 100 inactivates the interface and does not detect whether the external device 200 is connected.

When the external device 200 is connected, the electronic device 100 switches the mode to the normal mode and operates (S620). Specifically, an interrupt occurs due to the connection to the external device 200, the electronic device 100 may switch the mode to the normal mode according to the interrupt processing routine. Accordingly, the electronic device 100 supplies power to detect whether the external device 200 is connected while operating in the normal mode. Thus, the interface 100 may perform the operation of detecting whether the external device 200 is connected by Hot Plug Detect (HPD).

The method of switching the operation mode of the electronic device 100 according to the above-described various exemplary embodiments may be implemented as a program code executable by a computer, stored in a non-transitory computer-readable medium, and provided to each server or devices so that it can be executed by the processor 130.

For example, a program which performs the step of operating in the power save mode while an external device is not connected, the step of, in response to an external device being connected in the power save mode, generating an interrupt, and in response to determining that the interrupt occurs, switching the power save mode to the normal mode, may be stored in a non-transitory computer readable medium and provided.

A non-transitory computer readable medium may refer to a machine-readable medium or device that stores data semi-permanently, not for a short period of time, such as register, cache, memory, and the like. Specifically, the above-described program may be stored in the non-transitory computer readable medium such as a CD, a DVD, a hard disk, a Blu-ray player, a USB, a memory card, a ROM or etc., and provided.

The foregoing exemplary embodiments and advantages are merely exemplary and are not to be construed as limiting the present disclosure. The present teaching may be readily applied to other types of apparatuses. Also, the description of the exemplary embodiments of the present disclosure is intended to be illustrative, and not to limit the scope of the claims, and many alternatives, modifications, and variations will be apparent to those skilled in the art.

What is claimed is:

1. An electronic device, comprising:
an interface configured to be connected to an external device;
a detection circuit configured to generate an interrupt when the external device is connected to the interface in a power save mode while the interface is not activated; and
a processor configured to, in response to the interrupt occurring, activate the interface by converting the electronic device to be in a normal mode, and control the interface to detect whether the external device is connected.

2. The device as claimed in claim 1, wherein the detection circuit includes a pull-up resistor and a switching transistor.

3. The device as claimed in claim 2, wherein the detection circuit, in response to the external device being connected to the interface while outputting a high level, switches the switching transistor to output a low level,
wherein the processor, in response to a low level signal output from the detection circuit is transitioned from a high level to the low level, determines that the interrupt occurs.

4. The device as claimed in claim 3, wherein the detection circuit turns on the switching transistor which has been turned off according to a connection signal generated as the external device is connected to the interface, and outputs the low level when the pull-up resistor is connected to ground as the switching transistor is turned on.

5. The device as claimed in claim 1, wherein the processor controls the interface to detect whether the external device is detached from the interface in the normal mode, and when the external device is detached from the interface, converts an operating mode of the electronic device from the normal mode to the power save mode.

6. The device as claimed in claim 1, further comprising:
a display,
wherein the processor controls the display to display information regarding an operating mode in which the electronic device is operated and information regarding an input/output port to which the external device is connected from among a plurality of input/output ports of the interface.

7. A controlling method of an electronic device, the method comprising:
operating in a power save mode where whether an external device is connected is not detected;
generating an interrupt in response to the external device being connected; and
in response to the interrupt being generated, converting an operating mode to a normal mode where whether the external device is connected is detected.

8. The method as claimed in claim 7, wherein the interrupt is generated by a pull-up resistor and a switching transistor.

9. The method as claimed in claim 8, wherein generating the interrupt comprises:
in response to the external device being connected while the electronic device outputs a high level, outputting a low level by switching the switching transistor; and
in response to a signal output from the electronic device being transitioned from a high level to a low level, generating the interrupt.

10. The method as claimed in claim 9, wherein the outputting the low level comprises turning on the switching transistor which has been turned off according to a connection signal generated as the external device is connected, and outputting the low level when the pull-up resistor is connected to ground as the switching transistor is turned on.

11. The method as claimed in claim 7, further comprising:
detecting whether the external device is detached in the normal mode; and
when it is determined that the external device is detached, converting the operating mode from the normal mode to the power save mode.

12. The method as claimed in claim 7, further comprising:
displaying information regarding an operation mode of the electronic device and information regarding an input/output port of the electronic device to which the external device is connected.

13. A non-transitory computer readable medium storing a method as claimed in claim 7 for controlling an electronic device processor.
